(19) United States
(12) Patent Application Publication
(10) Pub. No.: US 2018/0035123 A1
(43) Pub. Date: Feb. 1, 2018

(54) Encoding and Decoding of Inter Pictures in a Video

(71) Applicant: Telefonaktiebolaget LM Ericsson (publ), Stockholm (SE)

(72) Inventors: Per Wennersten, Årsta (SE); Martin Pettersson, Vallentuna (SE); Jonatan Samuelsson, Enskede (SE)

(21) Appl. No.: 15/553,256

(22) PCT Filed: Feb. 25, 2015
(86) PCT No.: PCT/SE2015/050210

§ 371 Date: Aug. 24, 2017

(51) Int. Cl. H04N 19/503; H04N 19/70; H04N 19/44; H04N 19/593

(52) U.S. Cl. CPC H04N 19/503; H04N 19/593; H04N 19/70; H04N 19/44

(57) ABSTRACT

There are provided mechanisms for decoding a bitstream comprising a coded picture of a video sequence. The coded picture consists of at least one inter coded block of samples and at least one intra coded block of samples, wherein the inter coded block of samples succeeds the intra coded block of samples in a bitstream order. The method comprises reconstructing the inter coded block of samples before reconstructing the intra coded block of samples. There are provided mechanisms for encoding a picture of a video sequence. The picture comprises a block of samples and at least one of a right spatially neighboring block of samples and a bottom spatially neighboring block of samples. The method comprises predicting at least one of the right spatially neighboring block of samples and the bottom spatially neighboring block of samples with inter prediction. The method comprises predicting the block of samples from at least one of the right spatially neighboring block of samples and the bottom spatially neighboring block of samples that is predicted with inter prediction.

### TECHNICAL FIELD

Embodiments herein relate to the field of video coding, such as High Efficiency Video Coding (HEVC) or the like. In particular, embodiments herein relate to a method and a decoder for decoding a bitstream comprising a coded picture of a video sequence as well as a method and an encoder for encoding a picture of a video sequence. Corresponding computer programs therefor are also disclosed.

### BACKGROUND

State-of-the-art video coding standards are based on block-based linear transforms, such as a Discrete Cosine Transform (DCT). H.264/AVC and its predecessors define a macroblock as a basic processing unit that specifies the decoding process, typically consisting of 16×16 samples. A macroblock can be further divided into transform blocks, and into prediction blocks. Depending on a standard, the transform blocks and prediction blocks may have a fixed size or can be changed on a per-macroblock basis in order to adapt to local video characteristics.

The successor of H.264/AVC, H.265/HEVC (HEVC in short), replaces the 16×16 sample macroblocks with so-called coding tree units (CTUs) that can use the following block structures: 64×64, 32×32, 16×16 or 8×8 samples, where a larger block size usually implies increased coding efficiency. Larger block sizes are particularly beneficial for high-resolution video content. All CTUs in a picture are of the same size. In HEVC it is also possible to better sub-partition the picture into variable sized structures in order to adapt to different complexity and memory requirements.

When encoding a sequence of pictures constituting a video with HEVC, each picture 9 is first split into CTUs. A CTU 17 consists of three blocks, one luma and two chroma, and the associated syntax elements. These luma and chroma blocks are called coding tree blocks (CTB). A CTB has the same size as a CTU, but may be further split into smaller blocks—the so called coding blocks (CBs), using a tree structure and quadtree-like signaling. A size of a CB can vary from 8×8 pixels up to the size of a CTB. A luma CB, two chroma CBs and the associated syntax form a coding unit 18 (CU).

Compressing a CU 18 is performed in two steps. In a first step, pixel values in the CU 18 are predicted from previously coded pixel values either in the same picture or in previous pictures. In a second step, a difference between the predicted pixel values and the actual values, the so-called residual, is calculated and transformed with e.g. a DCT.

Prediction can be performed for an entire CU 18 at once or on smaller parts separately. This is done by defining Prediction Units (PUs), which may be the same size as the CU 18 for a given set of pixels, or further split hierarchically into smaller PUs. Each PU 19 defines separately how it will predict its pixel values from previously coded pixel values.

In a similar fashion, the transforming of the prediction error is done in Transform Units (TUs), which may be the same size as CUs or split hierarchically into smaller sizes. The prediction error is transformed separately for each TU 20. A PU 19 size can vary from 4×4 to 64×64 pixels for its luma component, whereas a TU 20 size can vary from 4×4 to 32×32 pixels. Different PU 19 and TU 20 partitions as well as CU 18 and CTU 17 partitions are illustrated in FIG. 1.

Prediction units have their pixel values predicted either based on the values of neighboring pixels in the same picture (intra prediction), or based on pixel values from one or more previous pictures (inter prediction). A picture that is only allowed to use intra-prediction for its blocks is called an intra picture (I-picture). The first picture in a sequence must be an intra picture. Another example of when intra pictures are used is for so-called key frames which provide random access points to the video stream. An inter picture may contain a mixture of intra-prediction blocks and inter-prediction blocks. An inter picture may be a predictive picture (P-picture) that uses one picture for prediction, and a bi-directional picture (B-picture) that uses two pictures for prediction.

Prior to encoding, a picture may be split up into several tiles, each consisting of M×N CTUs, where M and N are integers. When encoding, the tiles are processed in the raster scan order (read horizontally from left to right until the whole line is processed and then move to the line below and repeat the same process) and the CTUs inside each tile are processed in the raster scan order. The CUs in a CTU 17 as well as PUs and TUs within a CU 18 are processed in Z-scan order. This process is illustrated in FIG. 2. The same raster scan order and Z-scan order are applied when decoding a bitstream.

When decoding a CU 18 in a video bitstream, the syntax elements for the CU 18 are first parsed from the bitstream. The syntax elements are then used to reconstruct the corresponding block of samples in the decoded picture.

### SUMMARY

In current video coding standards encoding/decoding of an inter block is independent of the decoding of intra blocks. This holds even for intra blocks that precede the inter block in the raster scan order. Typically, an intra block is reconstructed by using its top and/or left spatially neighboring blocks as a reference since only these are available when predicting/reconstructing the current block due to the order in which the blocks are scanned. This means that, even if both top and left spatially neighboring blocks are used when predicting/reconstructing the current block, only half of the available spatially neighboring blocks is used. Having less spatially neighboring blocks used in prediction means having a worse quality of prediction. Worse quality of prediction means larger difference between the original block of pixels and the predicted block of pixels. Taking into account that this difference is further transformed and quantized prior to packing it in a bitstream, and the larger difference means more information to send, it is clear that worse prediction results in a higher bitrate.

Thus, in order to reduce the bitrate, it is of utter importance that the intra blocks are predicted as accurately as possible.

This and other objectives are met by embodiments as disclosed herein.

A first aspect of the embodiments defines a method, performed by a decoder, for decoding a bitstream comprising a coded picture of a video sequence. The coded picture consists of at least one inter coded block of samples and at least one intra coded block of samples, wherein the inter coded block of samples succeeds the intra coded block of samples in a bitstream order. The method comprises reconstructing the inter coded block of samples before reconstructing the intra coded block of samples.

A second aspect of the embodiments defines a decoder for decoding a bitstream comprising a coded picture of a video sequence. The coded picture consists of at least one inter coded block of samples and at least one intra coded block of samples, wherein the inter coded block of samples succeeds the intra coded block of samples in a bitstream order. The decoder comprises processing means operative to reconstruct the inter coded block of samples before reconstructing the intra coded block of samples.

A third aspect of the embodiments defines a computer program for decoding a bitstream comprising a coded picture of a video sequence. The coded picture consists of at least one inter coded block of samples and at least one intra coded block of samples, wherein the inter coded block of samples succeeds the intra coded block of samples in a bitstream order. The computer program comprises code means which, when run on a computer, causes the computer to reconstruct the inter coded block of samples before reconstructing the intra coded block of samples.

A fourth aspect of the embodiments defines a computer program product comprising computer readable means and a computer program, according to the third aspect, stored on the computer readable means.

A fifth aspect of the embodiments defines a method, performed by an encoder, for encoding a picture of a video sequence. The picture comprises a block of samples and at least one of a right spatially neighboring block of samples and a bottom spatially neighboring block of samples. The method comprises predicting at least one of the right spatially neighboring block of samples and the bottom spatially neighboring block of samples with inter prediction. The method comprises predicting the block of samples from at least one of the right spatially neighboring block of samples and the bottom spatially neighboring block of samples that is predicted with inter prediction.

A sixth aspect of the embodiments defines an encoder for encoding a picture of a video sequence. The picture comprises a block of samples and at least one of a right spatially neighboring block of samples and a bottom spatially neighboring block of samples. The encoder comprises processing means operative to predict at least one of the right spatially neighboring block of samples and the bottom spatially neighboring block of samples with inter prediction. The encoder comprises processing means operative to predict the block of samples from at least one of the right spatially neighboring block of samples and the bottom spatially neighboring block of samples that is predicted with inter prediction.

A seventh aspect of the embodiments defines a computer program for encoding a picture of a video sequence. The picture comprises a block of samples and at least one of a right spatially neighboring block of samples and a bottom spatially neighboring block of samples. The computer program comprises code means which, when run on a computer, causes the computer to predict at least one of the right spatially neighboring block of samples and the bottom spatially neighboring block of samples with inter prediction. The computer program comprises code means which, when run on a computer, causes the computer to predict the block of samples from at least one of the right spatially neighboring block of samples and the bottom spatially neighboring block of samples that is predicted with inter prediction.

An eighth aspect of the embodiments defines a computer program product comprising computer readable means and a computer program, according to the seventh aspect, stored on the computer readable means.

Advantageously, at least some of the embodiments provide higher compression efficiency.

It is to be noted that any feature of the first, second, third, fourth, fifth, sixth, seventh and eighth aspects may be applied to any other aspect, whenever appropriate. Likewise, any advantage of the first aspect may equally apply to the second, third, fourth, fifth, sixth, seventh and eighth aspect respectively, and vice versa. Other objectives, features and advantages of the enclosed embodiments will be apparent from the following detailed disclosure, from the attached dependent claims and from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention, together with further objects and advantages thereof, may best be understood by making reference to the following description taken together with the accompanying drawings, in which:

FIG. 1 illustrates different picture partitions for coding, prediction and transform used in HEVC.

FIG. 2 illustrates the order in which different picture partitions in HEVC are processed according to the raster scan order and the Z-scan order.

FIG. 3 illustrates directional intra prediction modes defined in HEVC (FIG. 3(A)), with a more detailed illustration of directional mode 29 (FIG. 3(B)).

FIG. 4 illustrates how intra prediction is performed by using spatially neighboring blocks as reference, as used in HEVC.

FIGS. 5 and 6 illustrate a flowchart of a method of decoding a bitstream comprising a coded picture of a video sequence, according to embodiments of the present invention.

FIG. 7 (A) illustrates the pixels from the neighboring blocks that are used for prediction in HEVC, whereas FIG. 7 (B) shows the pixels from the spatially neighboring blocks that are used for improved intra prediction according to some of the embodiments of the present invention.

FIG. 8 illustrates an intra prediction mode that uses samples from the right and bottom spatially neighboring blocks together with the samples from the top and left spatially neighboring blocks according to the embodiments of the present invention.

FIG. 9 illustrates and example of a signal that may be better predicted with the intra prediction mode depicted in FIG. 8 than with any of the existing intra prediction modes in HEVC.

FIGS. 10-12 illustrate flowcharts of a method of encoding a picture of a video sequence, according to embodiments of the present invention.

FIGS. 13 and 15 depict a schematic block diagram illustrating functional units of a decoder for decoding a bitstream of a coded picture of a video sequence according to embodiments of the present invention.

FIG. 14 is a schematic block diagram illustrating a computer comprising a computer program product with a computer program for decoding a bitstream of a coded picture of a video sequence according to embodiments of the present invention.

FIGS. 16 and 18 depict a schematic block diagram illustrating functional units of an encoder for encoding a picture of a video sequence according to embodiments of the present invention.

FIG. 17 is a schematic block diagram illustrating a computer comprising a computer program product with a computer program for encoding a picture of a video sequence, according to embodiments of the present invention.

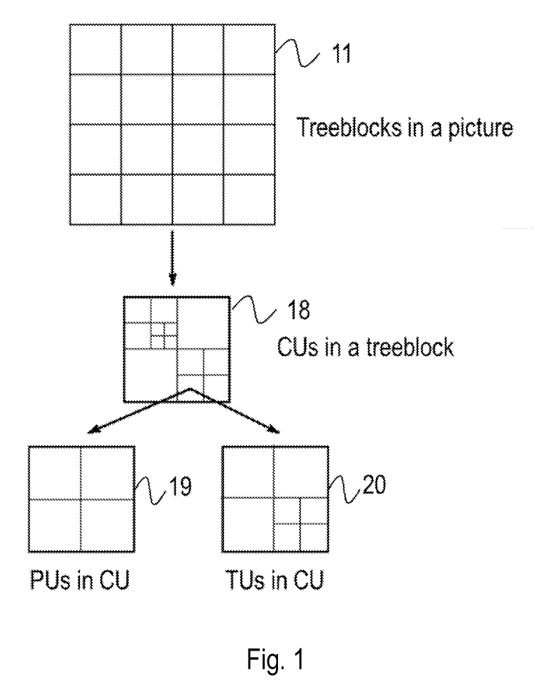

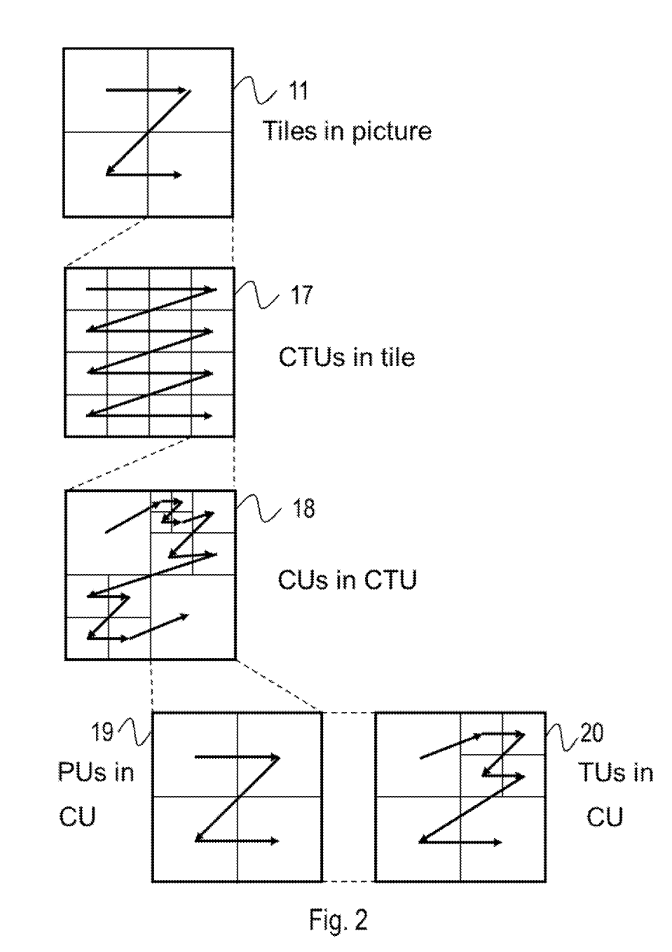

### DETAILED DESCRIPTION

The accompanying drawings, which are incorporated herein and form part of the specification, illustrate various embodiments of the present invention and, together with the description, further serve to explain the principles of the invention and to enable a person skilled in the art to make and use the invention. Throughout the drawings, the same reference numbers are used for similar or corresponding elements.

Throughout the description, the terms “video” and “video sequence”, “intra predicted block” and “intra block”, “inter predicted block” and “inter block”, “block of samples” and “block”, “pixel” and “sample” are interchangeably used.

Even though the description of the invention is based on the HEVC codec, it is to be understood by a person skilled in the art that the invention could be applied to any other state-of-the-art and a future block-based video coding standard.

The present embodiments generally relate to a method and a decoder for decoding a bitstream comprising a coded picture of a video sequence as well as a method and an encoder for encoding a picture of a video sequence.

Modern video coding standards use the so-called hybrid approach that combines inter-/intra-picture prediction and 2D transform coding. As already said, intra prediction refers to prediction of the blocks in a picture based only on the information in that picture. A picture whose all blocks are predicted with intra prediction is called an intra picture (or I-picture). For all other pictures, inter-picture prediction is used, in which prediction information from other pictures is exploited. A picture where at least one block is predicted with inter prediction is called an inter picture. This means that an inter picture may have blocks that are intra predicted.

After all the blocks in a picture are predicted and after additional loop filtering, the picture is stored in the decoded picture buffer so that they can be used for the prediction of other pictures. Thus a decoder loop is used in the encoder and is synchronized with the true decoder to achieve the best performance and avoid mismatch with the decoder.

HEVC defines 3 types of intra prediction: DC, planar and angular. The DC intra prediction mode uses for prediction an average value of reference samples. This mode is particularly useful for flat surfaces.

The planar mode uses average values of two linear predictions using four corner reference samples: it is essentially interpolating values over the block, assuming that all values to the right of the block are the same as the pixel one row above the block and one column to the right of the block. The values below the block are assumed to be equal to the pixel in the row below the block and the column to the left of the block. The planar mode helps in reducing the discontinuities along the block boundaries. HEVC supports all the block sizes, unlike in H.264/MPEG-4 AVC that supports plane prediction only for block sizes of 16×16.

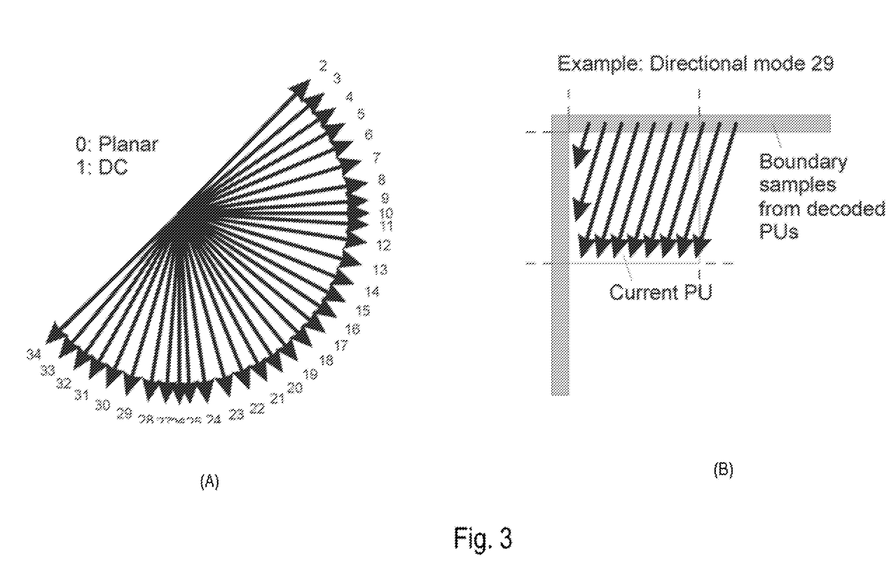

Intra angular prediction defines 33 prediction directions, unlike H.264/MPEG-4 AVC where only 8 directions are allowed. As can be seen in FIG. 3 (A), the angles corresponding to these directions are chosen to cover near-horizontal and near-vertical angles more densely than near-diagonal angles, which follows from the statistics on the directions that prevail when using this type of prediction, as well as how effective these directions are. With intra angular prediction, each block is predicted directionally from the reconstructed spatially neighboring samples. For a N×N block, up to 4N+1 neighboring samples are used. FIG. 3(B) shows an example of directional mode 29. Unlike H.264/MPEG-4 AVC, that uses different intra angular prediction methods depending on the block size (4×4, 8×8 and 16×16), the intra angular prediction in HEVC is consistent regardless of a block size.

Inter prediction takes advantage of temporal redundancy between neighboring pictures, thus typically achieving higher compression ratios. The sample values of an inter predicted block are obtained from the corresponding block from its reference picture that is identified by the so-called reference picture index, where the corresponding block is obtained by a block matching algorithm. The result of the block matching is a motion vector, which points to the position of the matching block in the reference picture. A motion vector may not have an integer value: both H.264/MPEG-4 AVC and HEVC support motion vectors with units of one quarter of the distance between luma samples. For non-integer motion vectors the fractional sample interpolation is used to generate the prediction samples for non-integer sampling positions, where an eight-tap filter is used for the half-sample positions and a seven-tap filter for the quarter-sample positions. The difference between the block to be inter predicted and the matching block is called a prediction error. Prediction error is further transform coded and the transform coefficients are quantized before being transmitted to a decoder together with motion vector information to a decoder.

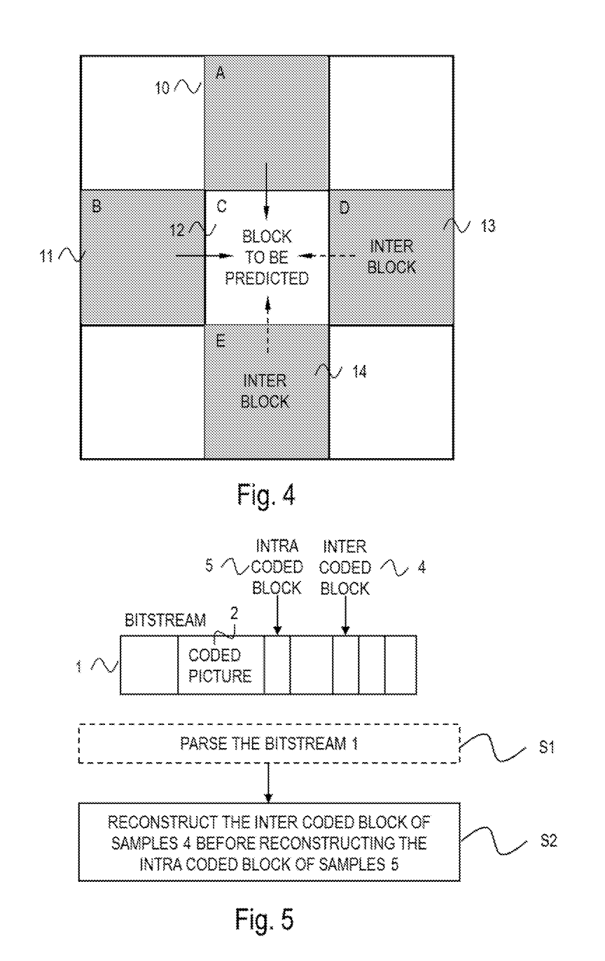

The fact that inter blocks are predicted independently from their spatially neighboring blocks can be exploited in order to improve prediction of intra blocks, as illustrated in FIG. 4. The block C 12 in this example is to be intra predicted. This means that it normally uses the (reconstructed) top spatially neighboring block A 10 and/or the (reconstructed) left neighboring block B 11 for prediction, as the blocks A 10 and B 11 precede block C 12 in the Z-scan order. Block D 13 is subsequently predicted and for this block the best mode turns out to be an inter prediction mode. As already explained, inter prediction means looking for a good matching block in one or more previously reconstructed pictures, thus block D 13 does not use block C 12 as a reference for prediction. Similarly, suppose that block E 14 is to be inter predicted. This implies again that block C 12 is not used as reference for block E 14. Therefore, block C 12 is not used as a reference for blocks D 13 and E 14, and none of the blocks D 13 and E 14 is used for prediction of block C 12. In such situations, it may be beneficial if block C 12 used block D 13 and/or block E 14 for its intra prediction in addition to blocks A 10 and B 11 since this may give a more accurate prediction for block C 12. More accurate prediction further implies a smaller prediction error and a lower bitrate.

Having blocks D 13 and E 14 used as reference for block C 12 means that blocks D 13 and E 14 have to be available for prediction when block C 12 is being predicted. This implies that blocks D 13 and E 14 already have to be encoded and consequently reconstructed in the decoding loop at the encoder so that they are available for prediction of block C 12. This also implies that one has to depart from a standard decoding where all the blocks are reconstructed in the same order as their syntax elements are parsed. Therefore, both encoding and decoding processes need to be modified to enable using more spatially neighboring blocks. In what follows we will first describe the decoding process, and then the encoding process will be explained.

According to one aspect, a method performed by a decoder 100, for decoding a bitstream 1 comprising a coded picture 2 of a video sequence 3 is provided, as shown in FIG. 5. The coded picture 2 consists of at least one inter coded block of samples 4 and at least one intra coded block of samples 5. The inter coded block of samples 4 succeeds the intra coded block of samples 5 in a bitstream 1 order. The bitstream order is to be understood as a raster scan order or a Z-scan order.

The inter coded block of samples 4 may be used for prediction of the intra coded block of samples 5. Moreover, the inter 4 and intra 5 coded block of samples may be spatially neighboring blocks of samples such that the inter coded block of samples 4 is located to the right or below the intra coded block of samples 5. Referring to FIG. 4, the inter coded block of samples 4 may correspond to block D 13 whereas the intra coded block of samples 5 may correspond to block C 12. The method comprises step S2 where the inter coded block of samples 4 is reconstructed before reconstructing the intra coded block of samples 5.

The method may optionally comprise step S1, performed before step S2, of parsing the bitstream 1 to obtain syntax information related to coding of the video sequence 3. The syntax information may include one or more of: picture size, block size, prediction mode, reference picture selection for each block, motion vectors and transform coefficients.

In one embodiment, the decoder 100 checks a prediction type for a block of pixels to be decoded and, if it is intra, refrains from reconstructing it at this point, and instead skips to the next block to be decoded. The intra block is then revisited after its spatially neighboring blocks from above and to the left, as well as from the right and/or below have been reconstructed, and it is reconstructed by using these spatially neighboring blocks.

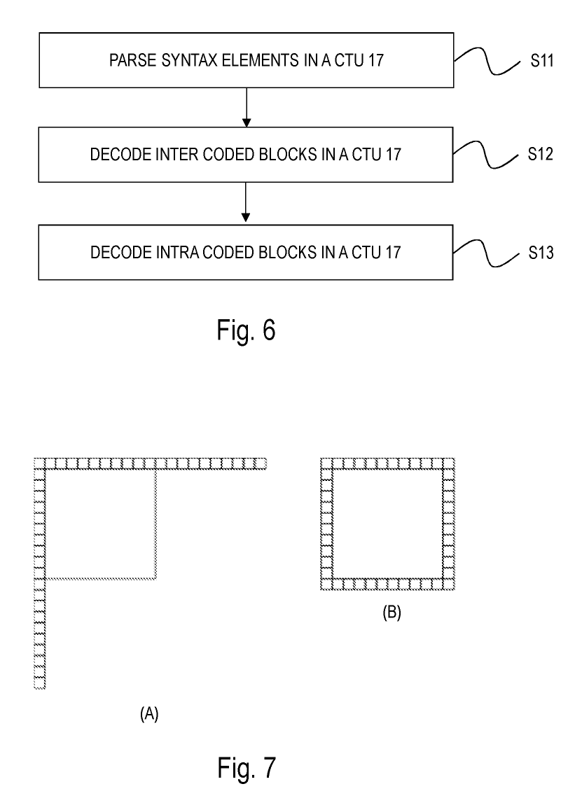

In another embodiment, the two passes that are performed in the decoder 100 are constrained to take place within a coding tree unit (CTU), thus forbidding the reconstruction across the CTU borders. Having this constraint also puts limits on the computational complexity in a sense that memory access is not increased in a typical implementation since a decoder would typically anyway hold at least an entire CTU in memory at the same time. The following steps, S11-S13, illustrated in FIG. 6, are 20 performed by the decoder 100 in this case:
1. All the syntax elements in a CTU are parsed (step S11)

In this step the bitstream 1 is parsed to obtain information related to coding of the video sequence 3. The syntax information includes one or more of: picture size, block size, prediction mode, reference picture selection for each block, motion vectors and transform coefficients. Parsing the syntax elements may be done in the bitstream order. However, it is also possible to parse the syntax elements for the inter coded blocks before parsing the syntax elements for the intra coded blocks within a CTU.
2. All the inter coded blocks in a CTU are decoded (step 512)

The inter coded blocks do not use any of the blocks in the current picture for prediction and can therefore be decoded independently and before the intra coded blocks.
3. All the intra coded blocks in a CTU are decoded (step S13)

After all the inter coded blocks have been decoded, all the intra CUs are decoded by possibly using more right and/or bottom spatially neighboring blocks in addition to the top and/or left neighboring block.

In another embodiment, some of the intra coded blocks that do not use right and/or bottom spatially neighboring blocks for prediction may be decoded in the first pass, together with the inter coded blocks, whereas the intra coded blocks that use right and/or bottom spatially neighboring blocks for prediction are decoded in the second pass.

In yet another embodiment, only the inter coded blocks that are used for intra prediction of their spatially neighboring blocks are reconstructed in the first pass, whereas the remaining inter coded blocks are reconstructed in the second pass.

In some situations it may occur that only parts of a spatially neighboring block are available due to that the spatially neighboring block is split into several sub-blocks out of which only a subset have been encoded in inter mode. This can be handled by interpolating or extrapolating values for those pixels that are not available for prediction, after which the reconstruction of the intra coded block is performed using these interpolated or extrapolated values.

The embodiments described above can be exploited, in the simplest case, by changing the intra prediction methods that the samples from the blocks located below and/or to the left of the current intra block can also be used, where available. Changing intra prediction modes requires modifications both on the encoder and the decoder side as the encoder and the decoder have to be synchronized in order to avoid prediction mismatch.

These new intra prediction modes are referred to as the improved intra prediction modes. FIG. 7 (A) illustrates the pixels from the neighboring blocks that are used for prediction in HEVC, whereas FIG. 7 (B) shows the bordering pixels from the spatially neighboring blocks that may be used for improved intra prediction according to some of the embodiments of the present invention.

Improved intra prediction modes may be obtained by modifying the existing intra prediction modes. For example, the DC intra prediction mode that simply predicts that the values in the block are equal to the average of the neighboring values can be extended in a straight-forward way by allowing for more neighboring pixels to be averaged for prediction. In the HEVC planar intra prediction mode it is assumed that all values to the right of the block are the same as the pixel one row above the block and one column to the right of the block. Similarly, the values below the block are assumed to be equal to the pixel in the row below the block and the column to the left of the block. This intra prediction mode can therefore be easily be extended by using the proper values to the right of or below the block where available instead of the assumed values.

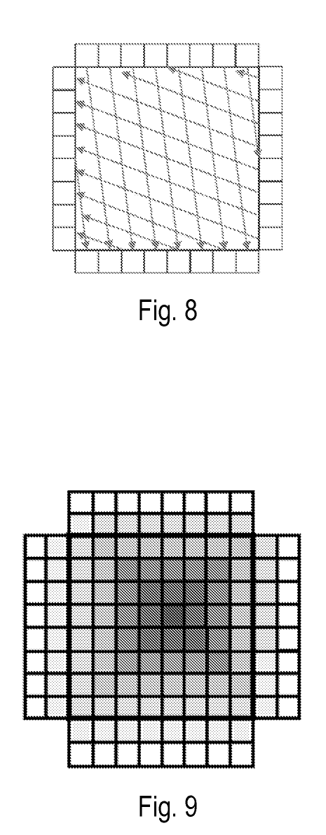

In addition to extending the existing intra prediction modes of HEVC, new intra modes that would benefit from using pixels from right and/or bottom blocks could be thought of. For instance, two different directions could be used for the angular mode, one direction as in HEVC (see FIG. 8) and one direction going in one of the opposite directions compared to the possible angular directions in FIG. 8. The pixel at the position where the two directions meet may be interpolated from the values of the bordering pixels from where the directions start and/or end. The interpolation could be made by using weights based on the distance to each pixel used for the interpolation or using some other way of calculating the weights.

The improved intra prediction modes may be combined with the existing intra prediction modes, or they may simply replace some of the existing intra prediction modes.

The improved intra prediction modes may use more rows/columns of pixels from the spatially neighboring blocks for prediction, rather than only the border row/column of pixels. This could for instance give better prediction for blocks that contain curved surfaces as the one illustrated in FIG. 9.

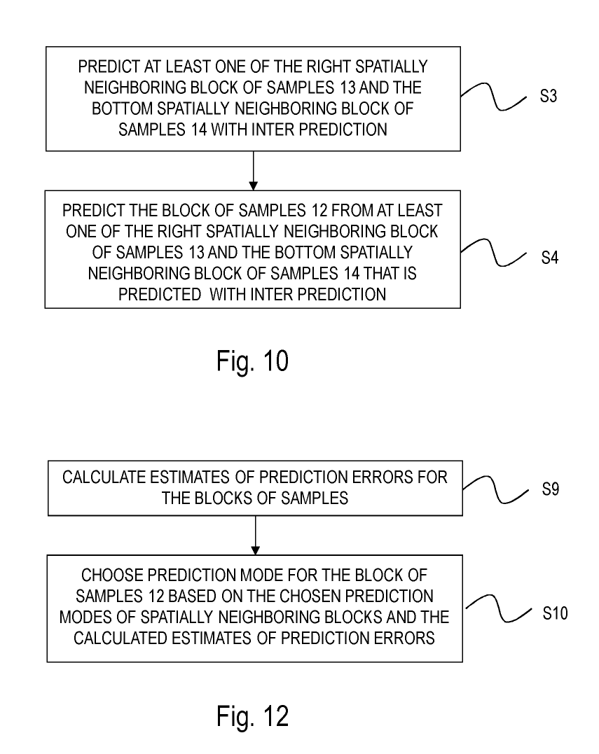

As already said, using more spatially neighboring blocks for prediction of a current block requires changes in the encoding process as well. According to one aspect of the embodiments, a method performed by an encoder, for encoding a picture 9 of a video sequence 3, wherein the picture comprises a block of samples 12 and at least one of a right spatially neighboring block of samples 13 and a bottom spatially neighboring block of samples 14 is disclosed. The flowchart of the method is depicted in FIG. 10. In step S3, at least one of the right spatially neighboring block of samples 13 and the bottom spatially neighboring block of samples 14 is predicted with inter prediction. In the next step (S4) the block of samples 12 is predicted from at least one of the right neighboring block of samples 13 and the bottom neighboring block of samples 14 that is predicted with inter prediction. This way the prediction of the block of samples is improved by taking more spatially neighboring inter predicted blocks of samples into account.

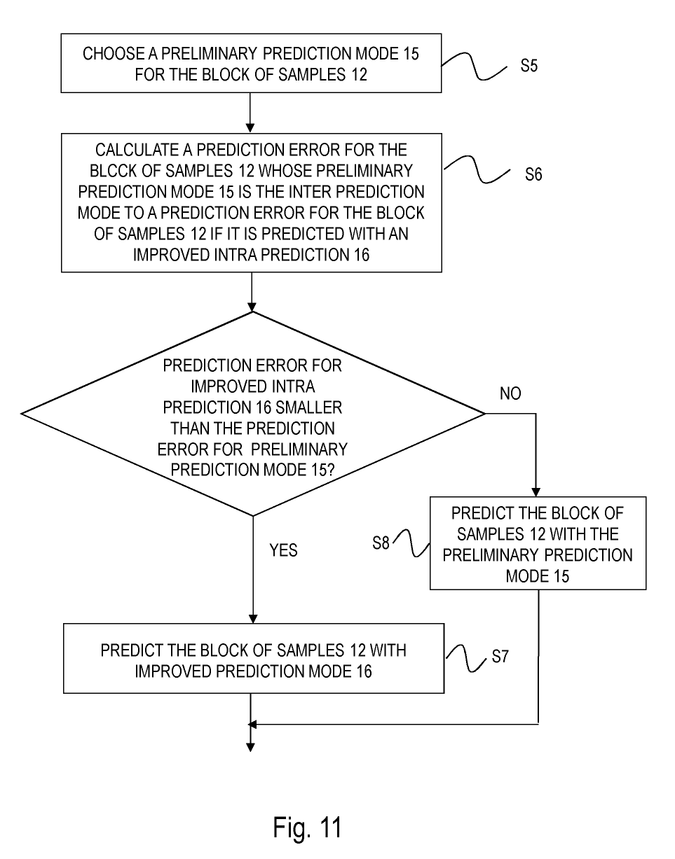

In one embodiment, depicted in FIG. 11, the encoding is performed as a two pass procedure. In the first pass (step S5), a preliminary prediction mode 15 is chosen for each block of samples 12 in a picture 9 among the existing inter and intra prediction modes, wherein the existing intra prediction modes perform prediction based on the top and/or left spatially neighboring blocks of samples. Thus the preliminary prediction mode 15 corresponds to the mode that would be used for the block of samples 12 if it was normally encoded, i.e. encoded with a standard encoder.

In the second pass, two prediction errors are calculated for the blocks of samples whose preliminary prediction mode 15 chosen in the first pass is inter mode (step S6). The first prediction error is the error corresponding to choosing the preliminary prediction mode 15. The prediction error is a function of the block of samples 12 and the predicted block of samples; for example the prediction error can be calculated as a mean squared error between the block of samples 12 and the reconstructed block of samples. The second prediction error corresponds to an error if an improved intra prediction 16 was used for that block of samples 12, where the improved intra prediction 16 is based on the spatially neighboring blocks of samples whose preliminary prediction mode 15 is the inter prediction mode.

The two prediction errors are compared and, if the prediction error corresponding to the improved prediction mode 16 is smaller than the one corresponding to the preliminary prediction mode 15, the block of samples 12 is predicted with the improved prediction mode 16 (step S7). That means that in the second pass it turned out that it is more beneficial to predict the block of samples 12 with improved intra prediction 16 than with inter prediction as there are neighboring inter predicted blocks that can be used to improve the prediction. If the prediction error corresponding to the preliminary prediction mode 15 is smaller than or equal to the one for the improved intra prediction mode 16, the block of samples is predicted the same way as with a normal encoding—with the preliminary prediction mode 15 (inter prediction in this case, step S8).

In another embodiment, depicted in FIG. 12, the encoding is performed by calculating (step S9), in a first pass, estimates of prediction errors for all blocks of samples, given they are predicted with intra prediction with different combinations of available spatially neighboring blocks of samples and with inter prediction. The prediction error is a function of the block of samples and the predicted block of samples, as in the previous embodiment. In the second pass, the prediction mode for the block of samples that is predicted first in the Z-scan order is chosen among different combinations of prediction modes for that block and the neighboring blocks such that its prediction error is minimized. The prediction mode for the second block of samples in the Z-scan order is chosen among different combinations of prediction modes for that block and the spatially neighboring blocks excluding the first block, given that the first block of samples is predicted with its chosen prediction mode. The second pass goes through all the blocks of samples and essentially repeats the same procedure: the prediction mode for a block of samples is chosen among different combinations of prediction modes for that block and the spatially neighboring blocks that precede that block in the Z-scan order, given that the spatially neighboring blocks that precede that block are predicted in their respective chosen prediction modes (step S10).

According to one embodiment it is not allowed to change a CU 18 size after the first pass. According to another embodiment splitting up a CU 18 into smaller parts is allowed after the first pass. In fact it could even be beneficial as each split CU 18 could use its own prediction mode.

The inter blocks of samples may be reconstructed including residual coding in the first pass. In another embodiment the inter blocks in the first pass are reconstructed without using residual coding. In the latter case the decoder would also need to use the reconstruction without residuals when evaluating the intra blocks in the second pass. The benefit of not using residual coded reconstructions for the prediction would be that some of the complexity of the encoder could be reduced while the compression efficiency of the intra coding may not suffer as much from having non-residual coded samples to predict from.

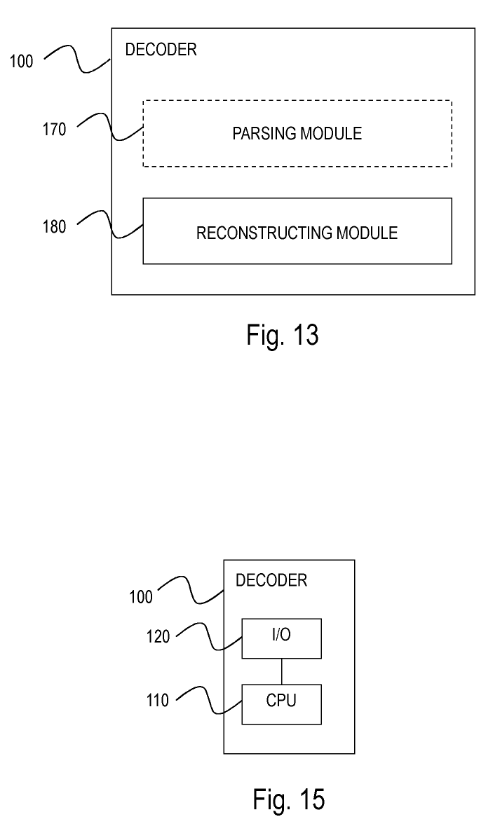

FIG. 13 is a schematic block diagram of a decoder 100 for decoding a bitstream 1 comprising a coded picture 2 of a video sequence, according to an embodiment (see also FIG. 5). The coded picture 2 consists of at least one inter coded block of samples 4 and at least one intra coded block of samples 5. The inter coded block of samples 4 succeeds the intra coded block of samples 5 in a bitstream 1 order. The decoder 100 comprises a reconstructing module 180, configured to reconstruct the inter coded block of samples 4 before reconstructing the intra coded block of samples 5. The decoder 100 further optionally comprises a parsing module 170 configured to parse the bitstream 1 to obtain syntax information related to coding of the video sequence 3.

The decoder 100 may be an HEVC or H.264/AVC decoder, or any other state of the art decoder that combines inter-/intra-picture prediction and block based coding.

The parsing module 170 may be a part of a regular HEVC decoder that parses the bitstream in order to obtain the information related to the coded video sequence such as: picture size, sizes of blocks of samples, prediction modes for the blocks of samples, reference picture selection for each block of samples, motion vectors for inter coded blocks of samples and transform coefficients.

The reconstructing module 180 may utilize the parsed syntax information from a parsing module 170 to reconstruct the pictures of the video sequence 3. For example, the reconstructing module 180 may obtain information on the prediction modes used for all the blocks of samples and can use this information to reconstruct the blocks of samples appropriately. In particular, the reconstructing module 180 is configured to reconstruct the inter coded block of samples 4 before reconstructing the intra coded block of samples 5 even though the inter coded block of samples 4 succeeds the intra coded block of samples in a bitstream order if the inter coded block of samples 4 is used for prediction of the intra coded block of samples 5. The reconstructing module may be configured to reconstruct all the inter coded blocks of samples before all the intra coded blocks of samples. Alternatively, it may be configured to reconstruct a subset of inter coded blocks of samples that are used for prediction of the intra coded blocks of samples before reconstructing all the intra coded blocks of samples.

The decoder 100 can be implemented in hardware, in software or a combination of hardware and software. The decoder 100 can be implemented in user equipment, such as a mobile telephone, tablet, desktop, netbook, multimedia player, video streaming server, set-top box or computer. The decoder 100 may also be implemented in a network device in the form of or connected to a network node, such as radio base station, in a communication network or system.

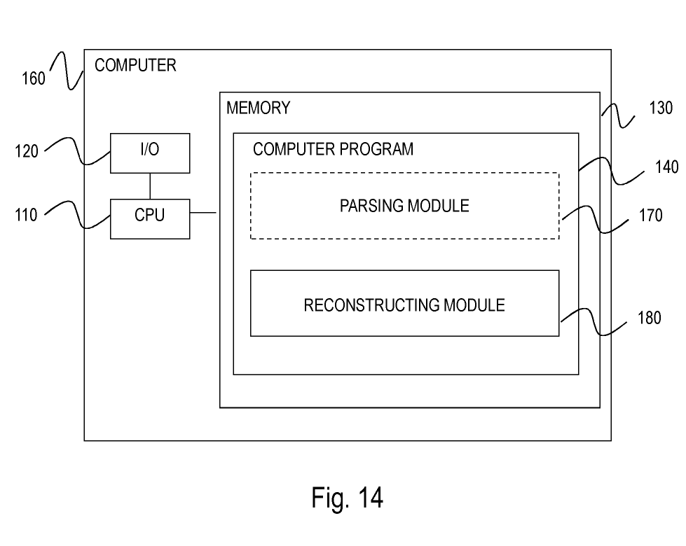

Although the respective units disclosed in conjunction with FIG. 13 have been disclosed as physically separate units in the device, where all may be special purpose circuits, such as ASICs (Application Specific Integrated Circuits). Alternative embodiments of the device are possible where some or all of the units are implemented as computer program modules running on a general purpose processor. Such an embodiment is disclosed in FIG. 14.

FIG. 14 schematically illustrates an embodiment of a computer 160 having a processing unit 110 such as a DSP (Digital Signal Processor) or CPU (Central Processing Unit). The processing unit 110 can be a single unit or a plurality of units for performing different steps of the method described herein. The computer also comprises an input/output (I/O) unit 120 for receiving a bitstream. The I/O unit 120 has been illustrated as a single unit in FIG. 14 but can likewise be in the form of a separate input unit and a separate output unit.

Furthermore, the computer 160 comprises at least one computer program product 130 in the form of a non-volatile memory, for instance an EEPROM (Electrically Erasable Programmable Read-Only Memory), a flash memory or a disk drive. The computer program product 130 comprises a computer program 140, which comprises code means which, when run on the computer 160, such as by the processing unit 110, causes the computer 160 to perform the steps of the method described in the foregoing in connection with FIG. 5.

According to a further aspect a decoder 100 for decoding a bitstream 1 comprising a coded picture 2 of a video sequence 3 is provided as illustrated in FIG. 15. The processing means are exemplified by a CPU (Central Processing Unit) 110. The processing means is operative to perform the steps of the method described in the foregoing in connection with FIG. 5. That implies that the processing means 110 are operative to reconstruct the inter coded block of samples 4 before reconstructing the intra coded block of samples 5. The processing means 110 may be further operative to parse the bitstream 1 to obtain syntax information related to coding of the video sequence 3.

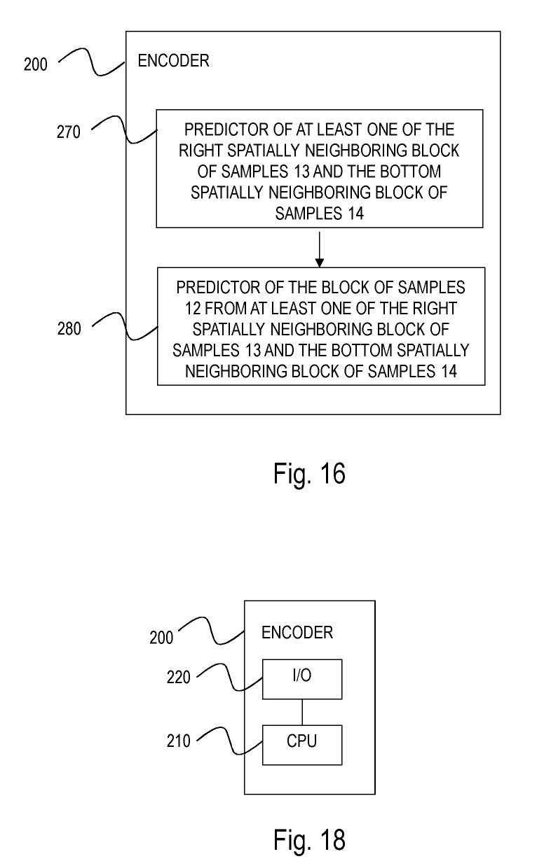

FIG. 16 is a schematic block diagram of an encoder 200 for encoding a picture 9 of a video sequence 3, according to an embodiment. The picture 9 comprises a block of samples 12 and at least one of a right spatially neighboring block of samples 13 and a bottom spatially neighboring block of samples 14. The encoder 200 comprises a predictor 270, configured to predict at least one of the right spatially neighboring block of samples 13 and the bottom spatially neighboring block of samples 14 with inter prediction. The encoder 200 further comprises a predictor 280, configured to predict the block of samples 12 from at least one of the right neighboring block of samples 13 and the bottom neighboring block of samples 14 that is predicted with inter prediction.

The encoder 200 may be an HEVC or H.264/AVC encoder, or any other state of the art encoder that combines inter-/intra-picture prediction and block based coding.

The predictor 270 may use the sample values in at least one of the blocks of samples 13 and 14 as well as the sample values in at least one of the previously encoded pictures to find good matching blocks that would be used for prediction of at least one of the blocks of samples 13 and 14. The matching blocks may be obtained by a block matching algorithm.

The predictor 280 may use the sample values from at least one of the blocks 13 and 14 that are predicted with inter prediction to predict the block of samples 12. The predictor 280 may use the improved intra prediction modes that use the samples from the top and/or left spatially neighboring blocks of samples in combination with the bottom and/or the right spatially neighboring blocks of samples. The improved intra prediction modes may be obtained by extending the existing intra prediction modes in e.g. HEVC. The predictor 280 may also use both existing and improved intra prediction modes in order to find the mode that best predicts the block of samples 12.

The encoder 200 can be implemented in hardware, in software or a combination of hardware and software. The decoder 200 can be implemented in user equipment, such as a mobile telephone, tablet, desktop, netbook, multimedia player, video streaming server, set-top box or computer. The encoder 200 may also be implemented in a network device in the form of or connected to a network node, such as radio base station, in a communication network or system.

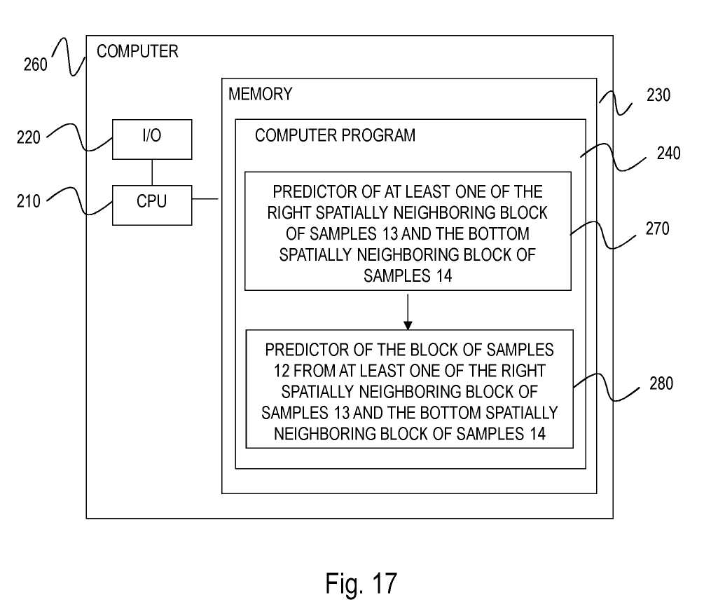

Although the respective units disclosed in conjunction with FIG. 16 have been disclosed as physically separate units in the device, where all may be special purpose circuits, such as ASICs (Application Specific Integrated Circuits). Alternative embodiments of the device are possible where some or all of the units are implemented as computer program modules running on a general purpose processor. Such an embodiment is disclosed in FIG. 17.

FIG. 17 schematically illustrates an embodiment of a computer 260 having a processing unit 210 such as a DSP (Digital Signal Processor) or CPU (Central Processing Unit). The processing unit 210 can be a single unit or a plurality of units for performing different steps of the method described herein. The computer also comprises an input/output (I/O) unit 220 for receiving a video sequence. The I/O unit 220 has been illustrated as a single unit in FIG. 17 but can likewise be in the form of a separate input unit and a separate output unit.

Furthermore, the computer 260 comprises at least one computer program product 230 in the form of a non-volatile memory, for instance an EEPROM (Electrically Erasable Programmable Read-Only Memory), a flash memory or a disk drive. The computer program product 230 comprises a computer program 240, which comprises code means which, when run on the computer 260, such as by the processing unit 210, causes the computer 260 to perform the steps of the method described in the foregoing in connection with FIG. 10.

According to a further aspect an encoder 200 for encoding a picture 9 of a video sequence 3 is provided as illustrated in FIG. 18. The picture 9 comprises a block of samples 12 and at least one of a right spatially neighboring block of samples 13 and a bottom spatially neighboring block of samples 14. The processing means are exemplified by a CPU (Central Processing Unit) 210. The processing means is operative to perform the steps of the method described in the foregoing in connection with FIG. 10. That implies that the processing means 210 are operative to predict at least one of the right spatially neighboring block of samples 13 and the bottom spatially neighboring block of samples 14 with inter prediction. That further implies that the processing means 210 are operative to predict the block of samples 12 from at least one of the right neighboring block of samples 13 and the bottom neighboring block of samples 14 that is predicted with inter prediction.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible.

1-32. (canceled)

33. A method, performed by a decoder, for decoding a bitstream comprising a coded picture of a video sequence, wherein the coded picture consists of at least one inter coded block of samples and at least one intra coded block of samples, wherein the inter coded block of samples succeeds the intra coded block of samples in a bitstream order, wherein the inter coded block of samples and the intra coded block of samples are spatially neighboring blocks of samples and wherein the inter coded block of samples is located to the right or below the intra coded block of samples, and wherein the inter coded block of samples is used for prediction of the intra coded block of samples, the method comprising:
reconstructing the inter coded block of samples before reconstructing the intra coded block of samples.

34. The method of claim 33, wherein the coded picture is split into at least one part of the picture, wherein all the inter coded blocks of samples from a part of the picture are reconstructed before all the intra coded blocks of samples from the same part of the picture.

35. The method of claim 34, wherein the part of the picture is a coding tree unit (CTU).

36. The method of claim 33, wherein the method comprises:
parsing the bitstream to obtain syntax information related to coding of the video sequence.

37. The method of claim 33, wherein the method comprises
parsing the syntax elements for the inter coded block before parsing the syntax elements for the intra coded block, and wherein the syntax information includes one or more of: picture size, block size, prediction mode, reference picture selection for each block, motion vectors and transform coefficients.

38. A method, performed by an encoder, for encoding a picture of a video sequence, wherein the picture comprises a block of samples and at least one of a right spatially neighboring block of samples and a bottom spatially neighboring block of samples, the method comprising:
predicting at least one of the right spatially neighboring block of samples and the bottom spatially neighboring block of samples with inter prediction;
predicting, with an intra prediction mode, the block of samples from at least one of the right spatially neighboring block of samples and the bottom spatially neighboring block of samples that is predicted with inter prediction.

39. The method of claim 38, the method comprising:
choosing a preliminary prediction mode for the block of samples in a first pass, among the existing inter and intra modes, wherein the existing intra modes perform prediction based on the top and/or left spatially neighboring blocks of samples;
calculating, in a second pass, a prediction error for the blocks of samples whose preliminary prediction mode is the inter prediction mode and a prediction error for the block of samples if it is predicted with an improved intra prediction mode, wherein the prediction error is a function of the block of samples and the predicted block of samples, and wherein the improved intra prediction mode is based on the spatially neighboring blocks of samples whose preliminary prediction mode is the inter prediction mode;
if the calculated prediction error for the block of samples with the improved intra prediction mode is smaller than the calculated prediction error for the block of samples with the preliminary prediction mode:
predicting the block of samples with the improved intra prediction mode;
if the calculated prediction error for the block of samples with the improved intra prediction mode is larger than or equal to the calculated prediction error for the block of samples with the preliminary prediction mode:
predicting the block of samples with the preliminary prediction mode.

40. A decoder for decoding a bitstream comprising a coded picture of a video sequence, wherein the coded picture consists of at least one inter coded block of samples and at least one intra coded block of samples, wherein the inter coded block of samples succeeds the intra coded block of samples in a bitstream order, wherein the inter coded block of samples and the intra coded block of samples are spatially neighboring blocks of samples and wherein the inter coded block of samples is located to the right or below the intra coded block of samples, and wherein the inter coded block of samples is used for prediction of the intra coded block of samples, the decoder comprising:
a processor; and
a memory operatively coupled to the processor and storing instructions executable by said processor, whereby said processor is operative to:
reconstruct the inter coded block of samples before reconstructing the intra coded block of samples.

41. The decoder of claim 40, wherein the instructions executable by said processor are configured such that the processor is further operative to:
parse the bitstream to obtain syntax information related to coding of the video sequence.

42. An encoder, for encoding a picture of a video sequence, wherein the picture comprises a block of samples and at least one of a right spatially neighboring block of samples and a bottom spatially neighboring block of samples, the encoder comprising:
a processor; and
a memory operatively coupled to the processor and storing instructions executable by said processor, whereby said processor is operative to:
predict at least one of the right spatially neighboring block of samples and the bottom spatially neighboring block of samples with inter prediction;
predict the block of samples from at least one of the right neighboring block of samples and the bottom neighboring block of samples that is predicted with inter prediction.

43. A non-transitory computer-readable medium comprising, stored thereupon, a computer program for decoding a bitstream comprising a coded picture of a video sequence, wherein the coded picture consists of at least one inter coded block of samples and at least one intra coded block of samples, wherein the inter coded block of samples succeeds the intra coded block of samples in a bitstream order, the computer program comprising program instructions which, when run on a computer, causes the computer to:
reconstruct the inter coded block of samples before reconstructing the intra coded block of samples.

44. A non-transitory computer-readable medium comprising, stored thereupon, a computer program for encoding a picture of a video sequence, wherein the picture comprises a block of samples and at least one of a right spatially neighboring block of samples and a bottom spatially neighboring block of samples, the computer program comprising program instructions which, when run on a computer, causes the computer to:
predict at least one of the right spatially neighboring block of samples and the bottom spatially neighboring block of samples with inter prediction;
predict the block of samples from at least one of the right neighboring block of samples and the bottom neighboring block of samples that is predicted with inter prediction.
